(19) United States
(12) Patent Application Publication
(10) Pub. No.: US 2026/0229130 A1
(43) Pub. Date: Aug. 6, 2026

(54) OPERATION CONTROL DEVICE AND OPERATION CONTROL METHOD

(71) Applicant: HITACHI, LTD., Tokyo (JP)

(72) Inventors: Takahiro ITO, Tokyo (JP); Mikio BANDO, Tokyo (JP); Mitsuru MATSUBARA, Tokyo (JP); Taku SHIMIZU, Tokyo (JP)

(21) Appl. No.: 19/099,492

(22) PCT Filed: Apr. 27, 2023
(86) PCT No.: PCT/JP2023/016670

§ 371 Date: Jan. 29, 2025

(30) Foreign Application Priority Data
Aug. 2, 2022 (JP) 2022-123566

(51) Int. Cl. G08G 5/34; G06F 16/29; G08G 5/76

(52) U.S. Cl. CPC G08G 5/34; G06F 16/29; G08G 5/76

(57) ABSTRACT

The flight vehicle operation management device includes: a weather information acquisition unit for acquiring weather information regarding a flight path of the flight vehicle; a flight vehicle information storage unit for storing flight vehicle information regarding the structure and capabilities of the flight vehicle; a map information storage unit for storing map information, including information regarding the living area and the topography thereof; a noise impact range estimation unit for calculating an impact range of noise generated by the flight vehicle on the basis of at least the weather information, the vehicle information regarding the structure and capabilities of the flight vehicle, the map information, and a flight plan; and a flight path designing unit for correcting the flight path on the basis of the noise impact range calculated by the noise impact range estimation unit.

### TECHNICAL FIELD

The present invention relates to an operation control device and an operation control method for controlling operation of an air vehicle, such as a vertical takeoff and landing aircraft.

### BACKGROUND ART

There has been known a system that controls operation of an aircraft etc., by setting a flight route and flight time in advance and allowing the aircraft to fly along the flight route during flight. For such a system, Patent Literature 1 or the like discloses a technique of setting a flight route based on information such as topographical information and map information.

In recent years, there has been a growing need for small electric vertical takeoff and landing aircrafts, which are expected to serve as a small, unmanned aircraft used for aerial photography and the like, a transportation, and a next-generation air transportation. Such aircrafts can advantageously fly along a variety of routes, including vertical takeoff and landing, by individually controlling motors provided on a plurality of respective rotor blades.

Although such aircrafts are expected to fly in a lower airspace than existing aircrafts, the used operation control method is for the flight based on a flight route based on topographical information and map information, and a flight plan of setting takeoff time and landing time, as with the existing aircrafts.

### CITATION LIST

### Patent Literature

### Patent Literature 1

Japanese Unexamined Patent Application Publication No. 2004-233082

### SUMMARY OF INVENTION

### Technical Problem

The small, unmanned aircraft and the small vertical take-off and landing aircraft fly in lower airspace than existing aircrafts as mentioned above, and will fly closer to human living areas than existing aircrafts because they are expected to fly in urban areas etc., for greater convenience in the future. It is therefore predicted that noise generated by the small, unmanned aircraft and the small vertical take-off and landing aircraft will be more likely to cause discomfort and anxiety to residents.

In the existing techniques typified by Patent Literature 1, no consideration is given to measures to prevent residents from feeling discomfortable or anxious due to noise generated by the air vehicles such as the small, unmanned aircraft and the small vertical take-off and landing aircraft.

An object of the present invention is therefore to provide an operation control device and an operation control method of an air vehicle, such as a small, unmanned aircraft or a small vertical takeoff and landing aircraft, which makes it possible to minimize noise impact when the air vehicle flies in the vicinity of human living areas, and thus reduce discomfort and anxiety of residents.

### Solution to Problem

To achieve the above object, the present invention is configured as follows.

An operation control device of an air vehicle includes: a weather information acquisition section that acquires weather information on a flight route of an air vehicle; an air-vehicle information storage section that stores information on a structure and performance of the air vehicle; a map information storage section that stores map information including information on a living area and topography; a noise impact range estimation section that calculates an impact range of noise generated by the air vehicle based on the weather information, the air vehicle information on the structure and the performance of the air vehicle, the map information, and the flight route, and/or other information; and a flight route designing section that modifies the flight route based on the impact range of the noise calculated by the noise impact range estimation section.

In an operation control method of an operation control device that controls an air vehicle that flies along a flight route, weather information for the flight route of the air vehicle is acquired, an impact range of noise generated by the air vehicle is calculated based on the weather information, air vehicle information on a structure and performance of the air vehicle, map information, and a flight plan, and/or other information, and the flight route is modified based on the calculated impact range of the noise.

### Advantageous Effects of Invention

According to the present invention, it is possible to provide an operation control device and an operation control method of an air vehicle, which each can minimize noise impact when the air vehicle, such as a small, unmanned aircraft or a small vertical takeoff and landing aircraft, flies in the vicinity of human living areas, and thus reduce discomfort and anxiety of residents.

### BRIEF DESCRIPTION OF DRAWINGS

FIG. 1 is a functional block diagram showing an exemplary configuration of an operation control device according to a first embodiment.

FIG. 2 is a schematic diagram showing noise level distribution on the assumption of flat topography in a uniform space in the first embodiment.

FIG. 3 is a schematic diagram showing changes in a noise impact range around an air vehicle due to wind conditions.

FIG. 4A is a schematic diagram showing changes in a noise impact range around an air vehicle due to temperature.

FIG. 4B is a schematic diagram showing changes in a noise impact range around an air vehicle due to temperature.

FIG. 5 is a schematic diagram showing a relationship between a map of an air vehicle and a surrounding area as viewed from above and a beforehand designed flight route for the air vehicle.

FIG. 6 is a flowchart showing processing of redesigning a flight route plan based on a noise impact range by the operation control device when a flight plan is prepared in advance in the first embodiment.

FIG. 7 is a schematic diagram showing a relationship between a map of an air vehicle and the surrounding area as viewed from above and a flight route redesigned for the air vehicle in the first embodiment.

FIG. 8 is a flowchart showing processing of another example of redesigning a flight route plan based on a noise impact range by the operation control device when a flight plan is prepared in advance in the second embodiment.

FIG. 9 is a schematic diagram showing a relationship between a map of an air vehicle and the surrounding area as viewed from above and a flight route redesigned for the air vehicle in the second embodiment.

FIG. 10 is a flowchart showing processing of another example of redesigning a flight route plan based on a noise impact range by the operation control device when a flight plan is prepared in advance in the third embodiment.

FIG. 11 is a schematic diagram showing a relationship between a map of an air vehicle and the surrounding area as viewed from above and a flight route redesigned for the air vehicle in the third embodiment.

FIG. 12 is a functional block diagram showing an exemplary configuration of an operation control device according to a fourth embodiment.

FIG. 13 is a schematic diagram showing a relationship between a map of an air vehicle and the surrounding area as viewed from above and a flight route redesigned for the air vehicle in the fourth embodiment.

FIG. 14 is a flowchart showing processing of redesigning a flight route plan and a flight speed plan based on a noise impact range by the operation control device during flight in the fourth embodiment.

### DESCRIPTION OF EMBODIMENTS

Hereinafter, some embodiments of the present invention will be described with reference to the drawings. Various components of the present invention do not necessarily need to be independent entities, and it is allowable that one component is made up of a plurality of components, the plurality of components are made up of one component, one component is part of another component, part of one component overlaps with part of another component, and the like.

### Embodiments

### First Embodiment

### <Schematic Configuration of Operation Control Device>

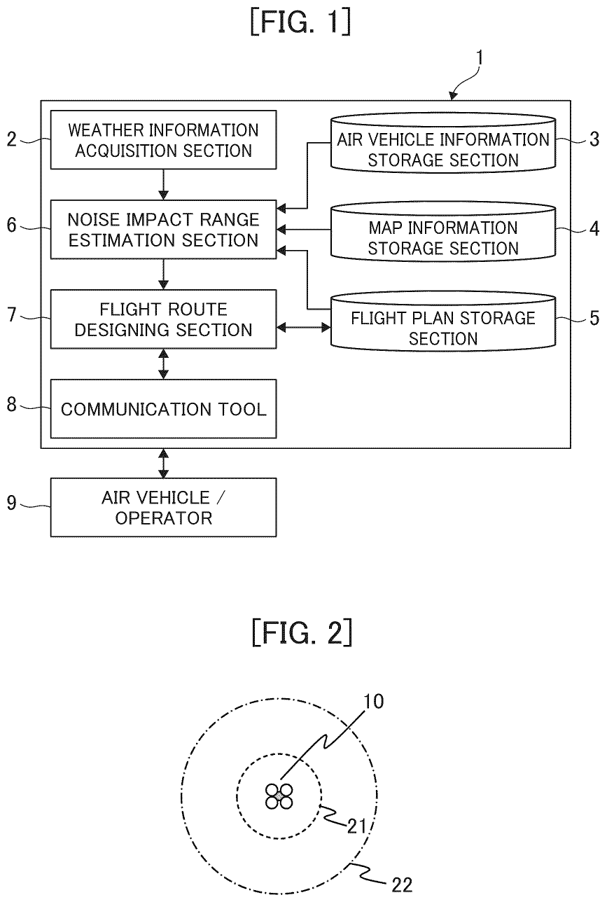

FIG. 1 is a conceptual diagram showing an operation control device 1 according to a first embodiment of the present invention. The operation control device 1 sets up a flight plan including a flight route, flight time, etc. before start of flight. The operation control device 1 modifies a route to an appropriate route at flight planning or during flight for a system of an air vehicle, which flies based on a flight plan, to guide the air vehicle, so that the impact of noise is minimized during flight in the vicinity of a city.

The operation control device 1 is installed, for example, in a portion of a facility of an operation control company.

The operation control device includes a weather information acquisition section 2 that acquires weather information around a flight area in which an air vehicle 10 flies, an air-vehicle information storage section 3 that stores a structure, performance, identification information, and specification information of the air vehicle 10 as an operation control object, a map information storage section 4 for storing information such as topographical information of an area where the air vehicle 10 flies and a living area. The living area refers to an area where people live. Examples of the living area include a house, an office building, and a residential area. The operation control device 1 further includes a flight plan storage section 5 that stores a flight plan including a flight route, a flight speed, etc. set for an air vehicle as an operation control object, a noise impact range estimation section 6 that estimates a range of impact of noise, generated by the air vehicle 10, on the surrounding of the flight route based on the weather information, the information on the structure and performance of the air vehicle, the map information, and the flight plan, and/or other information. The operation control device 1 further includes a flight route designing section 7 that modifies (redesigns) the flight route based on the noise impact range estimated by the noise impact range estimation section 6, and a communication tool 8 that communicates a change in the flight route to the air vehicle or an operator operating the air vehicle.

The weather information acquisition section 2 acquires current weather information such as a wind direction, wind speed, and temperature, which are collected from the ground to the sky by a plurality of weather sensors such as an aerovane and a thermometer installed around the flight area. The weather information acquisition section 2 is assumed to acquire prediction weather information, which is future information on the weather in a flight area of the air vehicle, using analysis etc.

The information stored or registered in the map information storage section 4 should include the registration number of the air vehicle, an aircraft type (multicopter, tiltrotor, fixed wing, etc.), propulsor specifications (power, rotor type, etc.), and a noise level (maximum value, value per rotor speed, etc.) of the air vehicle during flight. Such pieces of information are registered by an operator 9 of the air vehicle, an operation company, etc. at advance flight planning.

A method for setting the noise impact range by the noise impact range estimation section 6 is now described. The noise impact range refers to an impact range on the ground including buildings.

The noise impact range estimation section 6 sets a noise impact range based on the prediction weather information in the flight time zone scheduled in the flight plan, information on the air vehicle, the map information, and the flight plan. If a noise level (sound pressure), i. e., loudness of noise, of the air vehicle 10 (shown in FIG. 2) being a noise source is registered as a piece of air vehicle information, the registered value is used. Instead of the registered information, the noise level may be derived through calculation using a formula, analysis, or the like from information such as configuration information of the air vehicle 10 and a propulsion machine specification. In other words, it can be configured that the air-vehicle information storage section 4 has information on propulsion performance of the air vehicle 10 as aircraft information of the air vehicle 10, and the noise impact range estimation section 6 calculates the impact range of the noise generated by the air vehicle 10 being a noise source based on the information on the propulsion performance of the air vehicle 10.

Magnitude of the noise level propagating to the ground surface decreases in proportion to the logarithm of a distance from the noise source. As a result, simply assuming a uniform space on a flat ground surface, as shown in FIG. 2, the same noise levels will be distributed concentrically, as shown in a range 21 (dotted line) of a noise level P1 and a noise impact range 22 (dash-dotted line) being the range of a noise level P2.

The upper limit of the noise level around the residential area is set as a noise threshold Pth. The noise threshold Pth should be set based on, for example, regulatory values determined by environmental standards or allowable noise estimated from questionnaires to residents in the vicinity. For example, in FIG. 2, when the noise threshold Pth is P2, the inside of the dash-dotted line 22 is defined as the noise impact range.

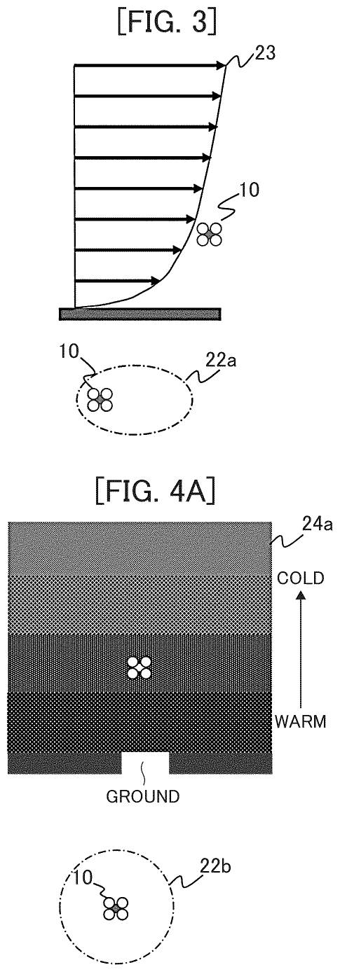

Noise propagation is also affected by weather. FIG. 3 shows changes in the noise impact range depending on wind speed. In FIG. 3, the arrows of the wind speed distribution 23 indicate vertical wind speed distribution toward the sky at one point on the ground, and the wind speed is generally higher in the upper air. When the wind speed is thus higher in the upper air, the noise impact range 22a in the vicinity of the ground surface propagates widely downwind as shown in FIG. 3. It is therefore preferable to calculate an expansion coefficient of a propagation range according to wind speed differences through advance analysis or the like, and set the noise impact range 22 so that the propagation range is expanded in the downwind direction according to a wind direction and wind speed based on wind condition information (included in weather information) including prediction information on the wind speed and the wind direction. In other words, the weather information includes the wind condition information including the prediction information on the wind speed and the wind direction, and the noise impact range estimation section 6 can be configured to set the noise impact range based on the expansion coefficient of the noise propagation range according to the wind speed.

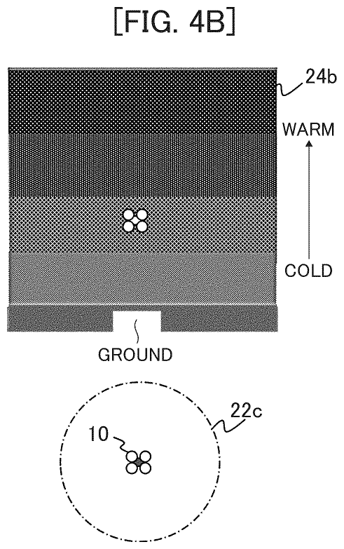

FIGS. 4A and 4B show, in terms of shades, changes in the noise impact range 22 according to temperature distributions in the vicinity of the ground and in the sky. FIG. 4A shows a temperature distribution 24a when temperature in the sky is lower than that in the vicinity of the ground surface, and FIG. 4B shows a temperature distribution 24b when temperature in the sky is higher than that in the vicinity of the ground surface. In the condition shown in the left figure, as shown by the noise impact range 22b in the vicinity of the ground surface, the distribution is narrower than in the case of no temperature difference. In the condition shown in the right figure, as shown by the noise impact range 22c, noise propagates farther and thus the distribution is wider than in the case of no temperature difference.

A change coefficient of a noise propagation range according to a temperature difference between temperature on the ground and temperature at a flight altitude of the air vehicle 10 is therefore calculated in advance by analysis etc., and the noise impact range estimation section 6 sets the noise impact range 22 based on the information on temperature difference included in the weather information. In other words, the weather information includes information on the temperature difference between the temperature on the ground and the temperature at the flight altitude of the air vehicle 10, and the noise impact range estimation section 6 sets the noise impact range based on the information on the temperature difference.

Although expansion or contraction of the noise impact range 22 may be simply set using a method based on weather information including a wind condition and temperature as described above, an accurate noise impact range may also be determined by a three-dimensional analysis in which weather information and topographical information are given as boundary conditions.

### <Air Vehicle 10 and Flight Condition>

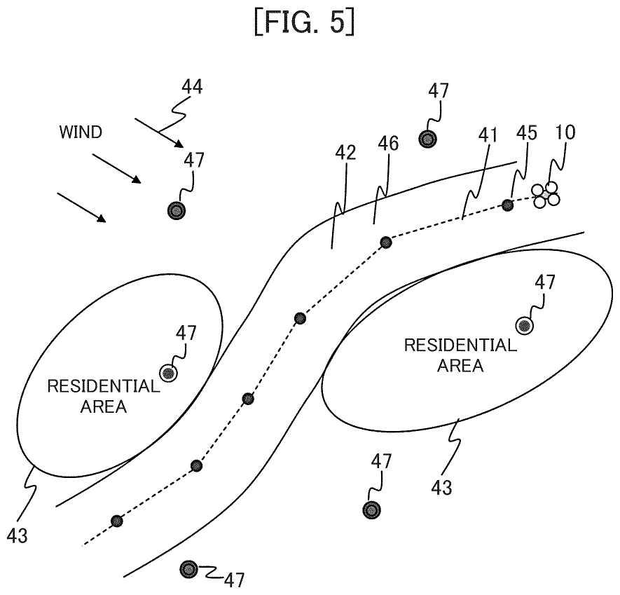

FIG. 5 schematically shows a flight route 41, which is beforehand designed for the air vehicle 10, on a map showing the air vehicle 10 and the surrounding condition as viewed from above. In the area shown in FIG. 5, the sky above a river 42 is set as a flight area 46 in which flight is allowed, and there are densely populated areas 43 being living areas on both sides of the river 42.

It is shown that the wind 44 in the sky is blowing from upper left to lower right in FIG. 5. The flight route 41 includes a plurality of waypoints 45 indicating coordinates on the map, where the plurality of waypoints 45 are provided in the center of the flight area 46 set above the river 42 at advance route planning. A plurality of weather sensors 47 are installed around the flight area 46. The weather sensors 47 are each connected to the operation control device 1 via a communication tool such as the Internet.

### <Example of Design Processing of Flight Route 41 at Preflight Flight Planning>

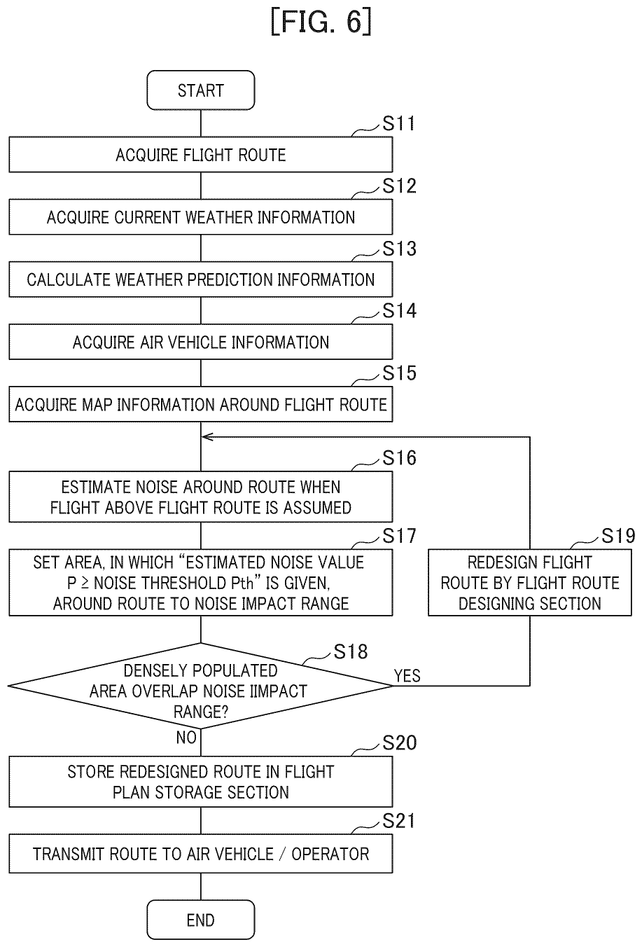

A design method of the flight route 41 at flight planning of the air vehicle 10 is now described with reference to the flowchart of FIG. 6.

At the start of the flowchart shown in FIG. 6, it is assumed that an initial flight plan is designed in advance and stored in the flight plan storage section 5.

In step S11, flight plan information, which is set in advance and stored in the flight plan storage section 5, is acquired, so that flight plan information, including the flight area 46, the flight route 41, and a flight time zone, is acquired. In subsequent step S12, current weather information is collected using the weather sensors 47 installed around the flight area, and the processing proceeds to step S13.

In step S13, weather prediction information is calculated using the collected current weather information. In subsequent step S14, the air vehicle information, which is stored and registered in the air-vehicle information storage section 3, is acquired. In subsequent step S15, map information around the flight route 41, which is stored in the map information storage section 4, is acquired. Such map information includes three-dimensional information on topography including structures on the ground, and location information on the densely populated area being the living area, such as the residential area. The noise impact range estimation section 6 sets the noise impact range 22 based on the information on the structures on the ground and the topography around the flight route 41.

In subsequent step S16, a noise level on the ground is estimated with the above-described estimation method using the noise impact range estimation section 6. In subsequent step S17, based on the noise level calculated in step S16, the area, in which the estimated noise level P around the flight route 41 is equal to or larger than the noise threshold Pth (estimated noise level P≥noise threshold Pth) is set as the noise impact range 22.

In subsequent step S18, the information on the densely populated area, which is the living area such as the residential area, acquired from the map information is referenced to check for overlap between the densely populated area and the noise impact range 22, and if there is any overlap, the processing proceeds to step S19. At this time, a change over time may be take into consideration for the information on the densely populated area. For example, the population density information around the flight route 41 at the time scheduled in the flight plan is referenced, and if the population density exceeds a certain value, the area is set as the densely populated area.

In subsequent step S19, if there is overlap between the densely populated area and the noise impact range 22, the flight route 41 is redesigned. More specifically, the flight route 41 is moved within the flight area 46 in a direction where the waypoints 45 are away from the residential area, etc. Steps S16 to S19 are then repeated until there is no overlap between the densely populated area and the noise impact range 22. When there is no longer any overlap between the densely populated area and the noise impact range 22, step S20 is performed.

In step S20, the redesigned flight route 41 or waypoints 45 is/are stored in the flight plan storage section 3, and update is performed. In subsequent step S21, the flight route 41 or the waypoints 45 is/are transmitted to the air vehicle 10 or an operator of the air vehicle 10.

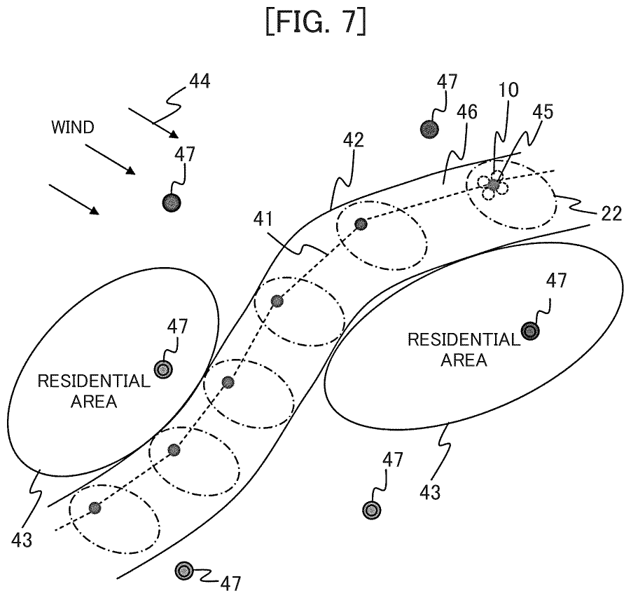

FIG. 7 shows a result of modifying the flight route 41 by executing the process according to the flowchart of FIG. 6 by the operation control device 1 of the first embodiment on a map of the same area as in FIG. 5 as viewed from above. The same components as in the example shown in FIG. 5 are designated by the same numerals, and description thereof is omitted.

As shown in FIG. 7, the waypoints 45 and the flight route 41 are redesigned to prevent the noise impact range 22 from overlapping with the residential area while taking into account the effects of weather.

As described above, the noise impact range 22 is estimated according to the prediction weather information at flight planning, and the flight route 41 is designed to prevent the noise impact range 22 from overlapping with the densely populated area, making it possible to reduce the impact of noise from the air vehicle 10 on people.

As a result, it is expected to reduce discomfort and anxiety among residents and increase social acceptance of flight in the vicinity of a city.

Although the noise threshold Pth has been described as a constant value, it may be changed depending on a time zone or a flight area. For example, if residents have a higher tolerance for noise during the daytime than the nighttime, since car noise may be expectably loud depending on a time zone along roads, etc., changing the noise threshold Pth depending on the time zone or the flight area increases the degree of design freedom of the flight route.

According to the first embodiment, it is possible to provide the operation control device 1 and an operation control method of the air vehicle 10, which each can minimize the noise impact when the air vehicle 10, such as a small, unmanned aircraft or a small vertical takeoff and landing aircraft, flies in the vicinity of a human living area, and can reduce discomfort and anxiety of the residents.

### Second Embodiment

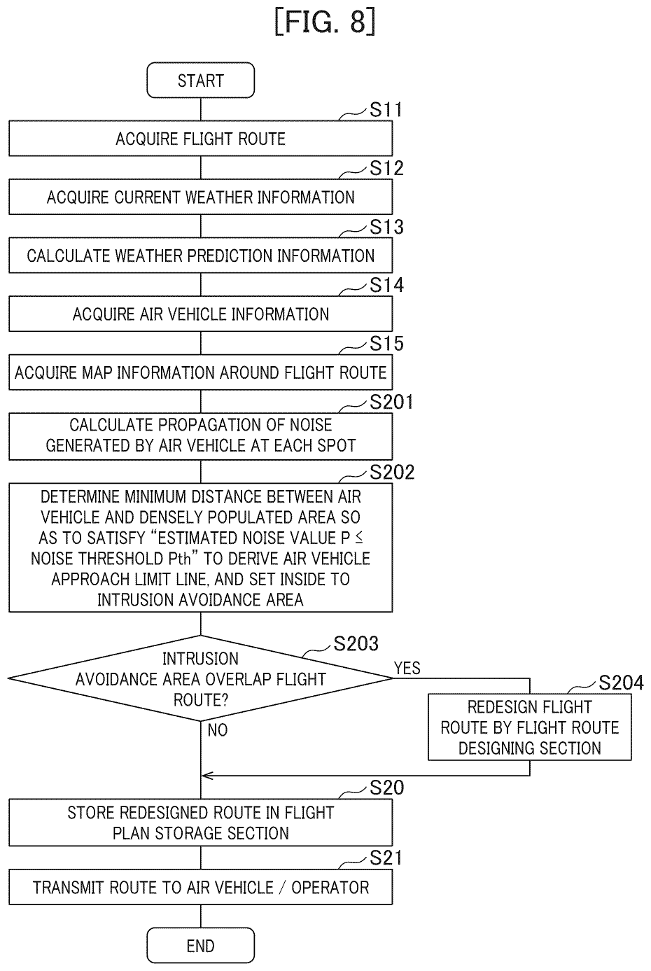

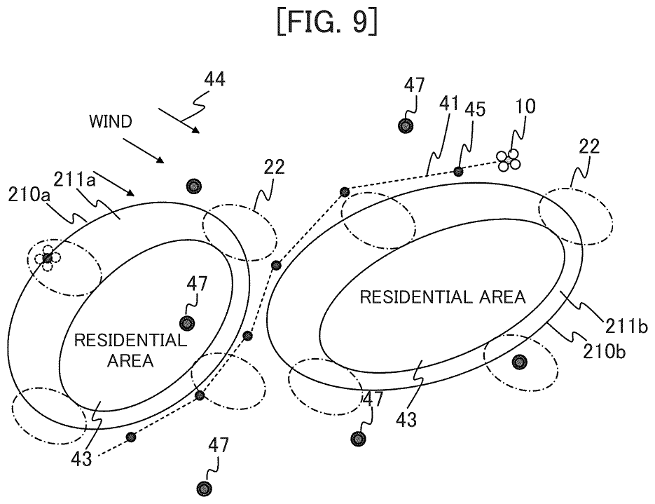

A second embodiment of the present invention is now described with reference to FIGS. 8 and 9. The configuration of the operation control device 1 of the second embodiment of the present invention is the same as that of the first embodiment shown in FIG. 1. FIG. 8 is a flowchart showing exemplary design processing of the flight route 41 at preflight flight planning by the operation control device 1 according to the second embodiment. The same components as those in the first embodiment are designated by the same signs, and detailed description thereof is omitted.

In the flowchart of FIG. 8, steps S11 to S15 are same as in the first embodiment, but subsequent steps S201 to S204 are different. Description of steps S11 to S15 is therefore omitted.

In step S201, the noise impact range estimation section 6 calculates a propagation condition of noise, which is generated by the air vehicle 10 when the air vehicle 10 flies over each point in the flight area, based on the prediction weather information and the map information, and estimates a noise level when the air vehicle 10 flies over the point.

In subsequent step S202, the minimum distance between the air vehicle 10 and the densely populated area, at which the estimated noise level P is equal to or less than the noise threshold Pth (estimated noise level P≤noise threshold Pth), is calculated to derive approach limit lines 210a and 210b of the air vehicle 10 to the densely populated areas. The respective areas closer to the densely populated areas than the approach limit lines 210a and 210b are set as intrusion avoidance areas (inside areas 211a and 211b of the approach limit lines) where the air vehicle 10 should avoid intrusion. The prediction information on the densely populated area 43 is stored in the map information storage section 4.

In subsequent step S203, check is performed for overlap between the intrusion avoidance area (the inside area 211a or 211b of the approach limit line) and the flight route 41. If there is an overlap, in step S204, the flight route designing section 7 redesigns the flight route 41 so that the waypoints 45 in the flight route 41 each do not overlap with the intrusion avoidance area (the inside area 211a or 211b of the approach limit line). In other words, the flight route designing section 7 designs the flight route 41 to avoid overlap between the noise impact range estimated by the noise impact range estimation section 6 and the densely populated area 43.

Subsequent steps S20 and S21 are the same as those in the first embodiment.

The approach limit lines 210a and 210b to the densely populated areas and the intrusion avoidance areas (areas 211a and 211b inside the approach limit lines) derived in steps S201 and S202 are now described with reference to FIG. 9. FIG. 9 shows a result of modifying the flight route 41 by executing, by the operation control device 1, the processing according to the flowchart of FIG. 8 on the map of the same area as in FIGS. 5 and 7 as viewed from above. In FIG. 9, the same components as those shown in FIGS. 5 and 7 are designated by the same numerals, and description thereof is omitted.

The approach limit lines 210a and 210b of the air vehicle 10 to the densely populated areas 43 (herein, the residential areas) in FIG. 9 are derived, for example, on the assumption that they are obtained by connecting the flight positions of the air vehicle 10 together with lines when each noise impact range 22 derived in the first embodiment is disposed so as not to overlap with the periphery of the densely populated area 43. Alternatively, when the air vehicle 10 is assumed to fly over each point, through three-dimensional noise analysis with the weather information, the map information, or the like of the entire flight area of the air vehicle 10 as a boundary condition, the minimum distance between the densely populated area 43 and the air vehicle 10, at which the noise in the densely populated area 43 is equal to or less than the noise threshold Pth, may be determined and defined to be the approach boundary line 210a or 210b.

According to such processing, it is possible to minimize the noise impact of the air vehicle 10 on the densely populated area 43 (residential area) substantially in the same manner as in the first embodiment, and thus reduce the discomfort and anxiety of the residents.

The second embodiment can also provide the same effects as the first embodiment.

### Third Embodiment

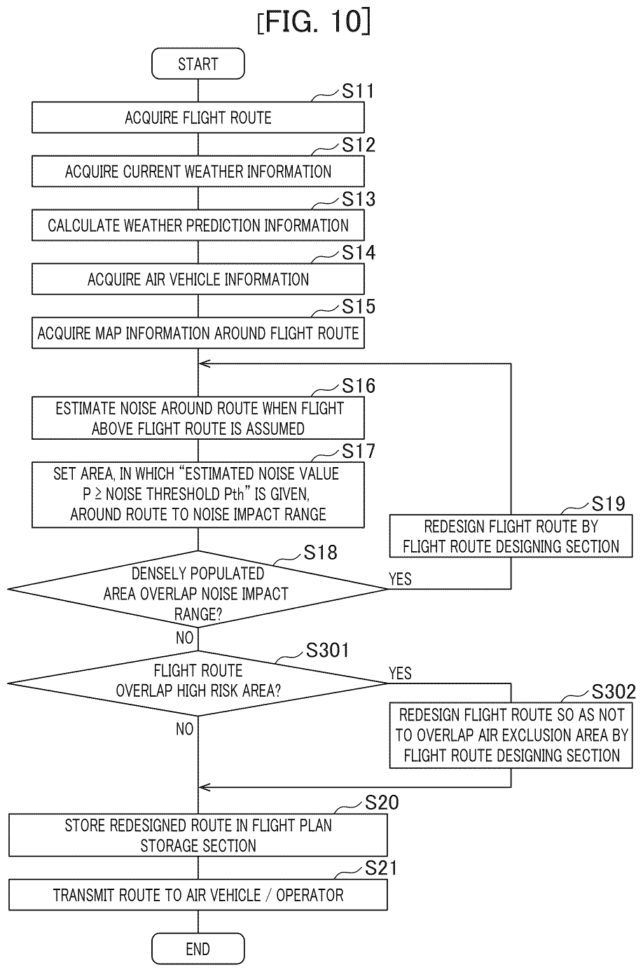

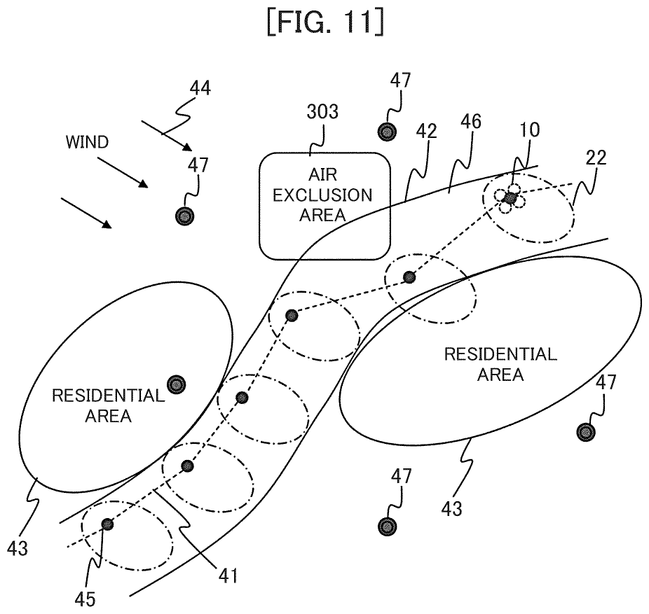

A third embodiment of the present invention is now described with reference to FIGS. 10 and 11. The configuration of the operation control device 1 of the third embodiment is the same as that of the first embodiment.

FIG. 10 is a flowchart showing exemplary design processing of the flight route 41 at preflight flight planning by the operation control device 1 according to the third embodiment. The same components as those in the first embodiment are designated by the same signs, and detailed description thereof is omitted.

In the flowchart of FIG. 10 in the third embodiment, steps S11 to S19, S20, and S21 are the same as in the first embodiment, but differ from the first embodiment in that steps S301 and S302 are added after the process of step S18.

If the densely populated area does not overlap with the noise impact range in step S18, the processing proceeds to step S301. In step S301, the flight route designing section 7 checks for overlap between the flight route 41 and an air exclusion area 303 being a high-risk area. FIG. 11 shows an example of the air exclusion area 303 being the high-risk area. Examples of the air exclusion area 303 include a place where an air vehicles are likely to be swept away by wind and in contact with a building, and an area where an event or the like is planned, and crowds are expected to gather.

The air exclusion area 303 should be set based on information detected by the sensor of the air vehicle 10 or based on advance event information. In such an air exclusion area 303, safety of the air vehicle 10 and safety on the ground must be a priority.

If overlap between the flight route 41 and the air exclusion area 303 is found in step S301, therefore, the processing proceeds to step S302, and the flight route designing section 7 designs the flight route 41 so as to allow overlap between the noise impact range 22 and the densely populated area 43 and avoid overlap between the flight route 41 and the air exclusion area 303. At this time, if the flight route 41 is designed so that the overlapping area of the noise impact range 22 and the densely populated area 43 is as small as possible, the noise impact can be reduced.

Adding such a process makes it possible to decrease the priority of noise reduction during flight and ensure design of a safe flight route 41, thus preserving safety during flight.

According to the third embodiment, it is possible to achieve the same effects as those of the first embodiment, and when the air exclusion area 303 exists, it is possible to design the flight route 41 so as to avoid the flight route 41, and minimize the overlapping area of the noise impact range 22 and the densely populated area 43.

In the example shown in FIG. 11, there is a portion where the noise impact range 22 of the air vehicle 10 two-dimensionally overlaps with the densely populated area 43 (residential area). In this case, the altitude of the air vehicle 10 can be adjusted to increase a vertical distance thereof from the densely populated area 43 so that the impact of noise is reduced.

However, if there is a limit on the flight altitude of the air vehicle 10, the altitude of the air vehicle 10 is adjusted within the limit.

### Fourth Embodiment

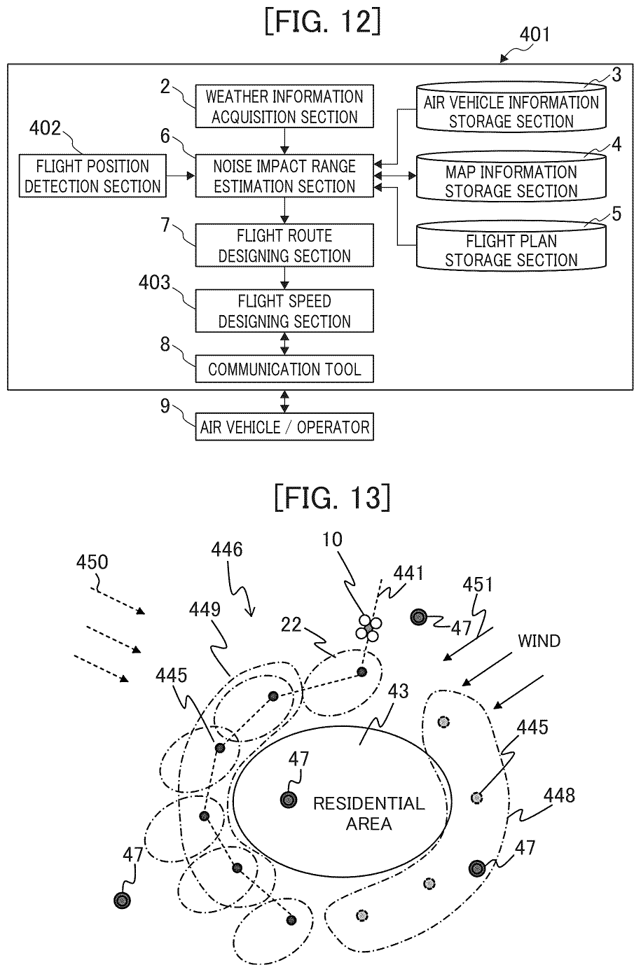

A fourth embodiment of the present invention is now described with reference to FIGS. 12, 13 and 14.

FIG. 12 shows the configuration of an operation control device 401 of the fourth embodiment, which differs from the operation control device 1 described in the first embodiment in that a flight position detection section 402 to detect a flight position of the air vehicle 10 during flight, and a flight speed designing section 403 to design a flight speed plan for the air vehicle 10 are added.

The flight position detection section 402 detects flight positional information, which is detected using positional information acquired by the air vehicle 10 using Global Navigation Satellite System (GNSS) or the like and transmitted to the operation monitoring device 401 via communication, and positional information of the air vehicle 10 acquired by a sensor, a radar, etc. installed on the ground. The flight speed designing section 403 changes a flight speed plan of the air vehicle 10 in order to suppress variations in time of arrival at a destination depending on flight conditions of the air vehicle 10. The flight plan is assumed to be made in advance as well as the route plan.

FIG. 13 is a schematic view of a flight route 441, beforehand designed for the air vehicle 10, on an aerial map of the air vehicle 10 and its surroundings. In the areas shown in FIG. 13, any area other than the densely populated area 43 (residential area) is set as a flight area 446 where flight is allowed.

As in FIG. 5, the plurality of weather sensors 47 are installed in the flight area 446.

The flight route 441 is configured of the plurality of waypoints 445 indicating coordinates on the map, and the waypoints 445 are set to avoid the densely populated areas 43. In FIG. 13, the waypoints 445 in the unchanged waypoint area 448 (within the range surrounded by a dash-dotted line) on the right of the densely populated area 43 are waypoints 445 set before execution of the processing of the fourth embodiment, and the waypoints 445 in the changed waypoint area 449 (within the range surrounded by the dash-dotted line 449) on the left of the densely populated area 43 are waypoints 445 the setting of which is changed through execution of the processing of the fourth embodiment.

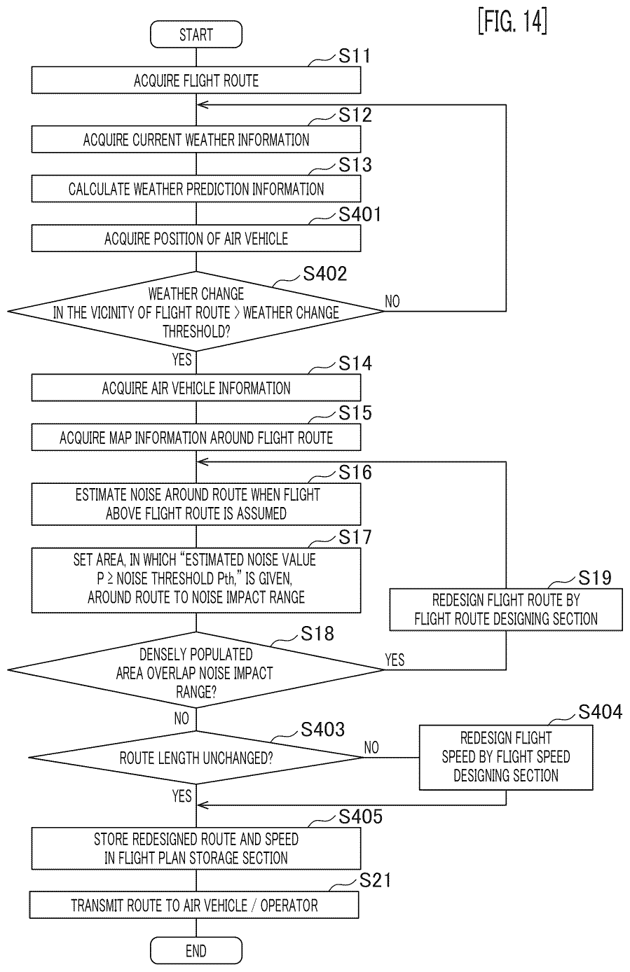

FIG. 14 is a flowchart showing a processing flow for the flight route modification and flight speed modification during flight of the air vehicle 10 by the operation control device 401 of the fourth embodiment. The same processes as in the flowchart of FIG. 6 in the first embodiment are designated by the same signs, and description thereof is omitted.

At the start of the flow of FIG. 14, the air vehicle 10 has begun a flight according to an advance flight plan.

A wind, which has been expected to blow from the upper left to the lower right in FIG. 13, such as a wind (unchanged) 450 indicated by the dotted arrow in the upper left of FIG. 13, is predicted to blow in a changed direction, i.e., in a direction from the upper right to the lower left in the figure, as shown by a wind (changed) 451 indicated by the solid arrow in the upper right of FIG. 13.

Steps S11 to S13 in FIG. 14 are the same processes as in the first embodiment and are performed at time intervals determined even during flight. In subsequent step S401, a position of the air vehicle 10 is detected using the flight position detection section 402. In subsequent step S402, it is determined whether a change in prediction weather information in the vicinity of the flight route 441, where the air vehicle 10 will fly in the future, exceeds a preset weather change threshold. The weather change threshold should be set with respect to, for example, the amount of change in wind direction, the amount of change in wind speed, the amount of change in temperature, or the like.

In step S402, if a weather change is equal to or less than the weather change threshold, steps S12 to S402 are repeated to continuously collect the weather information and the positional information of the air vehicle 10.

On the other hand, if the weather change exceeds the weather change threshold, the processes of modifying the flight route 441 shown in steps S14 to S19 are executed as in the first embodiment. Through the flight route modification, each waypoint 445 moves from the unchanged waypoint area 448 shown by a dash-dotted line, which has been located windward in the expectably changed wind direction, to the changed waypoint area 449 shown by a dash-dotted line located downwind, making it possible to prevent each noise impact range 22 from overlapping with the densely populated area 43.

If it is determined in step S18 that the densely populated area 43 does not overlap with any noise impact range 22, the processing proceeds to step S403.

In step S403, it is determined whether there is a change in the route length of the changed flight route 441. If there is no change in the route length, the flight route plan is stored in the flight plan storage section 5 in step S405.

If there is a change in the route length in step S403, the flight speed plan is redesigned in step S404. The flight speed plan is redesigned in the following manner, for example.

Assume that the flight start time Ts and the scheduled destination arrival time Te are set at advance flight planning, and according to the flight route 441 to the destination, a flight speed plan is set from the route length LO assumed in the advance flight route plan to enable arrival at the scheduled arrival time Te. Although the flight speed plan may be made to change the speed for each flight point, the flight speed is assumed to be set to a constant flight speed VO in this plan for simplicity of explanation. The time when the weather change in the vicinity of the flight route exceeds the weather change threshold in step S402 is set to T1.

Assuming that the route length for a flight from a current flight point of the air vehicle 10 to the changed flight route 441 is L1 while the destination arrival time Te is constant, in the case of a constant speed, changed flight speed V1 can be calculated by dividing the route length L1 by the destination arrival time Te minus the time T1 (V1=L1/(Te−T1)).

In step S405 subsequent to the process of step S404, the flight route plan and the flight speed plan are stored in the flight plan storage section 5. In subsequent step S21, the changed flight route plan and the changed flight speed plan are transmitted via the communication tool 8 to the air vehicle 10 or an operator of the air vehicle 10 (air vehicle/operator 9).

Adding such a configuration and processing makes it possible to change the flight route 441 during flight of the air vehicle 10. This will reduce the noise impact on a densely populated area such as a residential area during flight of the air vehicle 10, and thus reduce discomfort and anxiety of residents.

According to the fourth embodiment, when current or prediction information on the weather information or the map information varies, the flight route designing section 7 modifies the flight route 441 of the air vehicle 10 based on the noise impact range estimated by the noise impact range estimation section 6.

According to the fourth embodiment, when the flight distance to the destination of the air vehicle 10 is changed due to modification of the flight route 441, the flight speed designing section 403 redesigns the flight speed so that there is no delay in the arrival time to the destination.

As a result, according to the fourth embodiment, the following effects can be achieved, in addition to the same effects as those of the first embodiment.

Even if the flight route 441 is changed, a change in arrival time can also be minimized, resulting in a minimal reduction in convenience.

Although a change in prediction weather information is exemplarily used as a trigger for changing the flight route during flight in the fourth embodiment, similar effects can also be achieved by using a change in current weather information or a change in predicted population density condition on the ground as the trigger.

In the first to fourth embodiments, the noise impact range estimation section 6 can also set the noise impact range while dividing the densely populated area 43 into a plurality of areas according to population density, and changing the noise level according to the population density.

### LIST OF REFERENCE SIGNS

1, 401: operation control device, 2: weather information acquisition section, 3: air-vehicle information storage section, 4: map information storage section, 5: flight plan storage section, 6: noise impact range estimation section, 7: flight route designing section, 8: communication tool, 9: air vehicle/operator, 10: air vehicle, 21: noise level, 22, 22a, 22b, 22c: noise impact range, 23: wind speed distribution, 24a, 24b: temperature distribution, 41, 441: flight route, 42: river, 43: densely populated area, 44: wind (wind direction), 45: waypoint, 46: flight area, 47: weather sensor, 210a, 210b: approach limit line, 211a, 211b: inside area of approach limit line, 303: air exclusion area, 402: flight position detection section, 403: flight speed designing section, 445: waypoint 446: flight area, 448: unchanged waypoint area, 449: changed waypoint area, 450: wind (unchanged), 451: wind (changed)

1. An operation control device of an air vehicle, comprising:
a weather information acquisition section that acquires weather information on a flight route of the air vehicle;
an air-vehicle information storage section that stores information on a structure and performance of the air vehicle;
a map information storage section that stores map information including information on a living area and topography;
a noise impact range estimation section that calculates an impact range of noise generated by the air vehicle based on at least the weather information, the air vehicle information on the structure and the performance of the air vehicle, the map information, and the flight route, and/or other information; and
a flight route designing section that modifies the flight route based on the impact range of the noise calculated by the noise impact range estimation section.

2. The operation control device according to claim 1,
wherein the weather information includes wind condition information including prediction information on wind speed and a wind direction, and the noise impact range estimation section sets an impact range of the noise based on an expansion coefficient of a noise propagation range according to the wind speed.

3. The operation control device according to claim 1,
wherein the weather information includes information on a temperature difference between temperature on the ground and temperature at a flight altitude of the air vehicle, and the noise impact range estimation section sets the noise impact range based on the information on the temperature difference.

4. The operation control device according to claim 1,
wherein the map information storage section stores information on structures on the ground, and the noise impact range estimation section sets the noise impact range based on the information on the structures on the ground and the topography around the flight route.

5. The operation control device according to claim 1,
wherein the map information storage section includes predictive information on a densely populated area, and the flight route designing section designs the flight route to avoid overlap between the noise impact range estimated by the noise impact range estimation section and the densely populated area.

6. The operation control device according to claim 1,
wherein the air-vehicle information storage section includes information on propulsion performance of the air vehicle, and the noise impact range estimation section estimates an impact range of noise generated by the air vehicle being a noise source, based on the information on the propulsion performance.

7. The operation control device according to claim 1,
wherein when current or prediction information on the weather information or the map information varies, the flight route designing section modifies the flight route of the air vehicle based on the noise impact range estimated by the noise impact range estimation section.

8. The operation control device according to claim 7, further comprising,
a flight speed designing section that designs a plan of flight speed of the air vehicle, wherein when a flight distance to a destination of the air vehicle is changed due to modification of the flight route, the flight speed designing section redesigns the flight speed to prevent delay in arrival time to the destination.

9. The operation control device according to claim 1,
wherein when the flight route modified based on the impact range of the noise overlaps with an air exclusion area, the flight route designing section designs the flight route so as to allow overlap between the impact range of the noise and a densely populated area and avoid overlap between the flight route 41 and the air exclusion area.

10. The operation control device according to claim 1,
wherein the noise impact range estimation section sets the noise impact range while dividing the densely populated area into a plurality of areas according to population density, and changing a noise level according to the population density.

11. An operation control method of an operation control device that controls an air vehicle that flies along a flight route, the operation control method comprising:
acquiring weather information for the flight route of the air vehicle;
calculating an impact range of noise generated by the air vehicle, based on the weather information, air vehicle information on a structure and performance of the air vehicle, map information, and a flight plan, and/or other information; and
modifying the flight route based on the calculated impact range of the noise.

12. The method according to claim 11,
wherein the weather information includes wind condition information including prediction information on wind speed and a wind direction, and the nose impact range is set based on an expansion coefficient of a noise propagation range according to the wind speed.

13. The method according to claim 11,
wherein the weather information includes information on a temperature difference between temperature on the ground and temperature at a flight altitude of the air vehicle, and the noise impact range is set based on the information on the temperature difference.

14. The method according to claim 11,
wherein the noise impact range is set based on information on structures on the ground and topography around the flight route.

15. The method according to claim 11,
wherein the flight route is designed to avoid overlap between the calculated noise impact range and a densely populated area.
